(19) United States
(12) Patent Application Publication
(10) Pub. No.: US 2006/0088100 A1
(43) Pub. Date: Apr. 27, 2006

(54) Video coding method and apparatus supporting temporal scalability

(75) Inventors: Woo-jin Han, Suwon-si (KR); Kyo-hyuk Lee, Seoul (KR); Sang-chang Cha, Hwaseong-si (KR); Ho-jin Ha, Seoul (KR); Bae-keun Lee, Bucheon-si (KR); Jae-young Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/253,610

(22) Filed: Oct. 20, 2005

Related U.S. Application Data
(60) Provisional application No. 60/620,321, filed on Oct. 21, 2004.

(30) Foreign Application Priority Data
Dec. 8, 2004 (KR) 10-2004-0103076

(51) Int. Cl. H04N 11/02; H04N 11/04; H04N 7/12; H04B 1/66

(52) U.S. Cl. 375/240.16; 375/240.03; 375/240.18; 375/240.12; 375/240.23

(57) ABSTRACT

A method and apparatus for improving video coding efficiency by combining Motion-Compensated Temporal Filtering (MCTF) with closed-loop coding are provided. The video encoding method includes performing MCTF on input frames up to a first temporal level, performing hierarchical closed-loop coding on frames up to a second temporal level higher than the first temporal level, the frames being generated by the MCTF, performing spatial transform on frames generated using the hierarchical closed-loop coding to create transform coefficients, and quantizing the transform coefficients.

### CROSS-REFERENCE TO RELATED APPLICATIONS

This application claims priority from Korean Patent Application No. 10-2004-0103076 filed on Dec. 8, 2004 in the Korean Intellectual Property Office, and U.S. Provisional Patent Application No. 60/620,321 filed on Oct. 21, 2004 in the United States Patent and Trademark Office, the disclosures of which are incorporated herein by reference in their entirety.

### BACKGROUND OF THE INVENTION

1. Field of the Invention

Apparatuses and methods consistent with the present invention relate to video coding, and more particularly, to improving video coding efficiency by combining Motion-Compensated Temporal Filtering (MCTF) with closed-loop coding.

2. Description of the Related Art

With the development of information communication technology including the Internet, video communication as well as text and voice communication has increased. Conventional text communication cannot satisfy the various demands of users, and thus demand for multimedia services that can provide various types of information such as text, pictures, and music have increased. Multimedia data requires a large capacity storage medium and a wide bandwidth for transmission since the amount of multimedia data is usually large. For example, a 24-bit true color image having a resolution of 640*480 needs a capacity of 640*480*24 bits, i.e., data of about 7.37 Mbits, per frame. When this image is transmitted at a speed of 30 frames per second, a bandwidth of 221 Mbits/sec is required. When a 90-minute movie based on such an image is stored, a storage space of about 1200 Gbits is required. Accordingly, a compression coding method is a requisite for transmitting multimedia data including text, video, and audio.

A basic principle of data compression is removing data redundancy. Data can be compressed by removing spatial redundancy in which the same color or object is repeated in an image, temporal redundancy in which there is little change between adjacent frames in a moving image or the same sound is repeated in audio, or mental visual redundancy taking into account human eyesight and limited perception of high frequency signals. Data compression can be classified into lossy/lossless compression according to whether source data is lost, intraframe/interframe compression according to whether individual frames are compressed independently, and symmetric/asymmetric compression according to whether time required for compression is the same as time required for recovery. Data compression is defined as real-time compression when a compression/recovery time delay does not exceed 50 ms and as scalable compression when frames have different resolutions. For text or medical data, lossless compression is usually used. For multimedia data, lossy compression is usually used. Meanwhile, intraframe compression is usually used to remove spatial redundancy, and interframe compression is usually used to remove temporal redundancy.

Different types of transmission media for multimedia have different performance. Currently used transmission media have various transmission rates. For example, an ultrahigh-speed communication network can transmit data of several tens of megabits per second while a mobile communication network has a transmission rate of 384 kilobits per second. In conventional video coding methods such as Motion Picture Experts Group (MPEG)-1, MPEG-2, H.263, and H.264, temporal redundancy is removed by motion compensation based on motion estimation and compensation, and spatial redundancy is removed by transform coding. These methods have satisfactory compression rates, but they do not have the flexibility of a truly scalable bitstream since they use a reflexive approach in a main algorithm. Accordingly, to support transmission media having various speeds or to transmit multimedia at a data rate suitable to a transmission environment, data coding methods having scalability, such as wavelet video coding and subband video coding, may be suitable to a multimedia environment. Scalability indicates the ability to partially decode a single compressed bitstream. Scalability includes spatial scalability indicating a video resolution, Signal to Noise Ratio (SNR) scalability indicating a video quality level, and temporal scalability indicating a frame rate.

Among many techniques used for wavelet-based scalable video coding, MCTF that was introduced by Ohm and improved by Choi and Wood is an essential technique for removing temporal redundancy and for video coding having flexible temporal scalability. In MCTF, coding is performed on a group of pictures (GOP) and a pair of a current frame and a reference frame are temporally filtered in a motion direction.

FIG. 1 shows a conventional encoding process using 5/3 MCTF. A high-pass frame is shadowed in gray and a low-pass frame is indicated by white. A video sequence is subjected to a plurality of levels of temporal decompositions, thereby achieving temporal scalability.

Referring to FIG. 1, at temporal level 1, a video sequence is decomposed into low-pass and high-pass frames. Temporal prediction, i.e., both forward and backward prediction is performed on three adjacent input frames to generate a high-pass frame. Two adjacent high-pass frames are used to perform temporal update on an input frame.

At temporal level 2, temporal prediction and temporal update are performed again on the updated low-pass frames. By repeating four levels of temporal decompositions in this way, one low-pass frame and one high-pass frame are obtained at the highest temporal level.

An encoder end sends one low-pass frame at the highest temporal level and 15 high-pass frames to a decoder end that then reconstructs initial frames at all the temporal levels to obtain a total of 16 decoded frames.

As described above, MCTF involves a temporal update step following a temporal prediction step in order to reduce drifting error caused due to a mismatch between an encoder and a decoder. The update step allows a drifting error to be uniformly distributed across a group of pictures (GOP), thereby preventing the error from periodically increasing or decreasing. However, when a temporal interval between high-pass and low-pass frames increases as the temporal level increases, a significant amount of time delay may be introduced to perform forward prediction or updating. One of proposed approaches to achieve low time delay in a MCTF structure is to omit forward prediction and update steps for frames at temporal levels higher than a specific temporal level.

FIG. 2 illustrates a conventional method of limiting time delay in MCTF. When a maximum time delay is four, forward update and predictions are omitted for frames being updated at temporal level 2 and frames at higher temporal levels. Here, 1 time delay refers to one frame interval. For example, a minimum time delay required to generate a high-pass frame 15 is four because there is 1 time delay before an encoder receives an input frame 10. No forward update is performed for the update step at temporal level 2 because six time delays are introduced to perform forward update for a low-pass frame 20 although the maximum time delay is four. However, skipping forward prediction and update steps in the MCTF structure makes it difficult to uniformly distribute drifting error, thereby resulting in significant degradation of coding efficiency or visual quality.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

The present invention provides a method for solving a time delay problem in an MCTF structure.

The present invention also provides a method of combining advantages of both MCTF and closed-loop coding.

According to an aspect of the present invention, there is provided a video encoding method supporting temporal scalability, including the steps of: performing Motion-Compensated Temporal Filtering (MCTF) on input frames up to a first temporal level; performing hierarchical closed-loop coding on frames up to a second temporal level higher than the first temporal level, the frames being generated by the MCTF; performing spatial transform on frames generated using the hierarchical closed-loop coding to create transform coefficients; and quantizing the transform coefficients.

According to another aspect of the present invention, there is provided a video decoding method supporting temporal scalability, including extracting texture data and motion data from an input bitstream, performing inverse quantization on the texture data to output transform coefficients, using the transform coefficients to generate frames in a spatial domain, using an intra-frame and an inter-frame among the frames in the spatial domain to reconstruct low-pass frames at a specific temporal level, and performing inverse MCTF on high-pass frames among the frames in the spatial domain and the reconstructed low-pass frames to reconstruct video frames.

### BRIEF DESCRIPTION OF THE DRAWINGS

The above and other aspects of the present invention will become more apparent by describing in detail exemplary embodiments thereof with reference to the attached drawings in which:

FIG. 1 illustrates a conventional encoding process using 5/3 MCTF;

FIG. 2 illustrates a conventional method for limiting time delay in MCTF;

FIG. 3 is a block diagram of a video encoder according to an exemplary embodiment of the present invention;

FIG. 4 illustrates a method of referencing a frame in a MPEG coding scheme;

FIG. 5 is a block diagram showing the detailed construction of the video encoder of FIG. 3;

FIG. 6 is a diagram for explaining an unconnected pixel;

FIG. 7 illustrates an example of an encoding process including prediction and update steps for temporal levels 1 and 2 performed by a MCTF coding unit and those for higher temporal levels performed by a closed-loop coding unit;

FIG. 8 illustrates another example of an encoding process in which a MCTF coding unit performs up to a prediction step for a specific temporal level;

FIG. 9 illustrates an example of an encoding process in which closed-loop coding is applied to a Successive Temporal Approximation and Referencing (STAR) algorithm;

FIG. 10 shows an example of an encoding process using both forward and backward prediction for all temporal levels without considering time delay;

FIG. 11 shows an example of an encoding process using another group of pictures (GOP) as a reference;

FIG. 12 is a block diagram of a video decoder according to an exemplary embodiment of the present invention;

FIG. 13 is a block diagram showing the detailed construction of the video decoder of FIG. 12;

FIG. 14 illustrates a decoding process including hierarchical closed-loop decoding and MCTF decoding performed in reverse order of the encoding process illustrated in FIG. 7; and

FIG. 15 is a block diagram of a system for performing encoding and decoding processes according to an exemplary embodiment of the present invention.

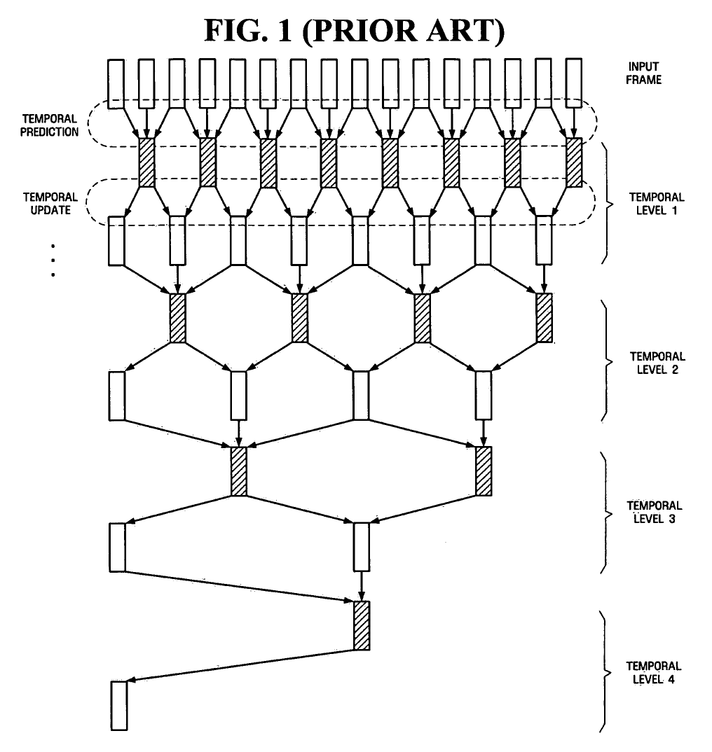

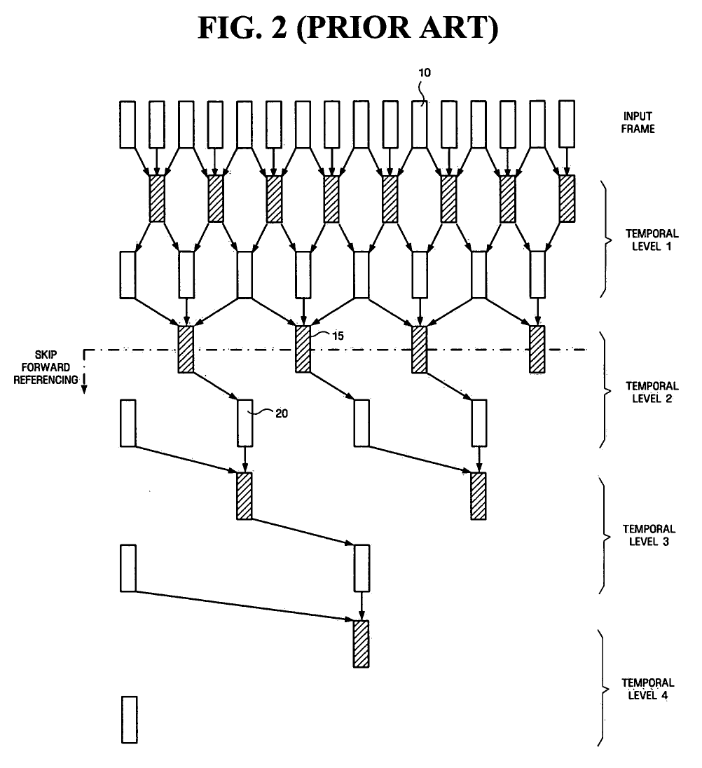

### DETAILED DESCRIPTION OF EXEMPLARY EMBODIMENTS OF THE INVENTION

Aspects of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

The present invention will now be described more fully with reference to the accompanying drawings, in which exemplary embodiments of the invention are shown.

An exemplary embodiment of the present invention proposes a method for improving Motion-Compensated Temporal Filtering (MCTF) by applying closed-loop coding for a specific temporal level and higher. It is known that a closed-loop coding method has better coding efficiency than an open-loop method when it does not include a forward update step. The proposed method involves determining which temporal level to apply hierarchical closed-loop coding to and replacing all frames at the determined temporal level with decoded frames than are then used as reference frames during prediction. The method reduces a mismatch in high-pass frame between encoder and decoder, thereby improving the overall coding efficiency. This concept can be implemented using a hybrid coding scheme combining MCTF and closed-loop coding.

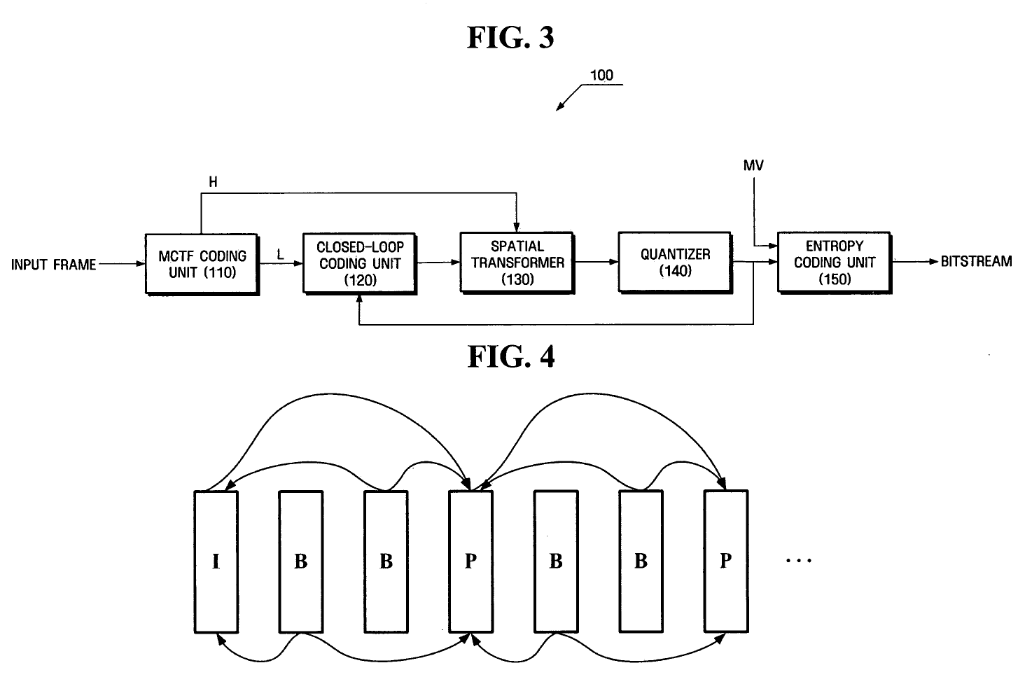

FIG. 3 is a block diagram of a video encoder 100 according to an exemplary embodiment of the present invention. Referring to FIG. 3, the video encoder 100 includes an MCTF coding unit 110, a closed-loop coding unit 120, a spatial transformer 130, a quantizer 140, and an entropy coding unit 150.

The MCTF coding unit 110 performs MCTF up to a temporal prediction step or temporal update step for a specific temporal level. The MCTF includes temporal prediction and temporal update steps for a plurality of temporal levels. The MCTF coding unit 110 can determine up to which temporal level MCTF is performed according to various conditions, in particular, maximum time delay. High-pass frames generated by the operation of the MCTF coding unit 110 are sent directly to the spatial transformer 130 while the remaining low-pass frames are sent to the closed-loop coding unit 120 for closed-loop coding.

The closed-loop coding unit 120 performs hierarchical closed-loop coding on a low-pass frame for a specific temporal level received from the MCTF coding unit 110. In closed-loop coding typically used in MPEG-based codecs or H.264 codecs, as shown in FIG. 4, temporal prediction is performed on a B or P frame using a decoded frame (I or P frame) as a reference frame instead of an original input frame. While the closed-loop coding unit 120 uses a decoded frame for temporal prediction like in FIG. 4, it performs closed-loop coding on a frame having a hierarchical structure to achieve temporal scalability unlike in FIG. 4. Furthermore, unlike MCTF coding, the closed-loop coding uses only a previous frame as a reference (i.e., forward prediction).

Thus, the closed-loop coding unit 120 performs temporal prediction on a low-pass frame received from the MCTF coding unit 110 to generate an inter-frame. Temporal prediction is iteratively performed on the remaining low-pass frames at temporal levels up to the highest temporal level to produce inter-frames. If the number of low-pass frames received from the MCTF coding unit 110 is N, the closed-loop coding unit 120 produces one intra-frame and N−1 inter-frames. Alternatively, in a case where the highest temporal level is determined in a different way, closed-loop coding may be performed up to a temporal level for which two or more intra-frames are produced.

To avoid confusion, the following terms needs to be precisely and clearly defined. “Low-pass frame” and “high-pass frame”, as used herein, respectively refer to frames generated by an update step and a temporal prediction step in MCTF.

“Intra-frame” and “inter-frame” respectively denote a frame encoded without reference to any other frame and a frame encoded with reference to another frame among frames generated by closed-loop coding. Although closed-loop filtering uses input low-pass frames (updated with reference to another frame) to generate an intra-frame and an inter-frame, a frame encoded without reference to any other frame during closed-loop filtering may also be called an intra-frame. The closed-loop coding uses a decoded version of a low-pass frame as a reference for temporal prediction. Because the closed-loop coding does not include the step of updating an intra-frame unlike the MCTF coding, an intra-frame does not change according to a temporal level.

The spatial transformer 130 performs spatial transform on a high-pass frame generated by the MCTF coding unit 110 and an inter-frame and an intra-frame generated by the closed-loop coding unit 120 in order to create transform coefficients. Discrete Cosine Transform (DCT) or wavelet transform techniques may be used for spatial transform. A DCT coefficient is created when DCT is used for spatial transform while a wavelet coefficient is produced when wavelet transform is used.

The quantizer 140 performs quantization on the transform coefficients obtained by the spatial transformer 130. Quantization is the process of converting real-valued DCT coefficients into discrete values by dividing the range of coefficients into a limited number of intervals and mapping the real-valued coefficients into quantization indices according to a predetermined quantization table.

The entropy coding unit 150 losslessly encodes the coefficients quantized by the quantizer 140 and the motion data (motion vectors and block information) obtained for temporal prediction by the MCTF coding unit 110 and the closed-loop coding unit 120 into an output bitstream. Various coding schemes such as Huffman Coding, Arithmetic Coding, and Variable Length Coding may be employed for lossless coding.

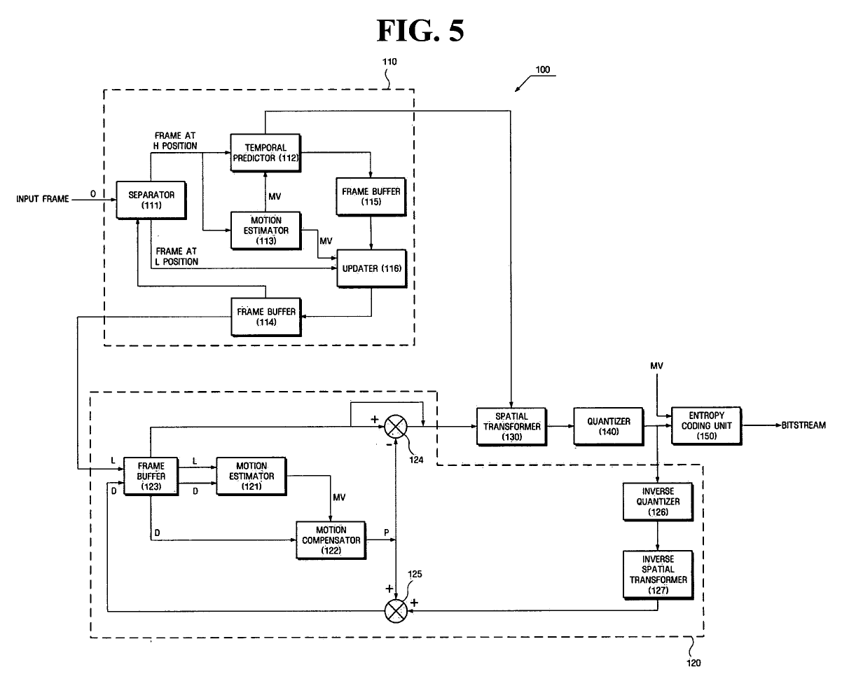

FIG. 5 is a block diagram showing the detailed construction of the video encoder 100 of FIG. 3. Referring to FIG. 5, the MCTF coding unit 110 includes a separator 111, a temporal predictor 112, a motion estimator 113, frame buffers 114 and 115, and an updater 116.

The separator 111 separates input frames into frames at high-pass frame (H) positions and frames at low-pass frame (L) positions. In general, a high-pass frame and a low-pass frame are located at an odd-numbered ((2i+1)-th) position and an even-numbered (2i-th) position where i is an index denoting a frame number and has an integer value greater than or equal to 0.

The motion estimator 113 performs motion estimation on a current frame at an H position using adjacent frames as a reference to obtain motion vectors. In this case, the adjacent frames refer to at least one of two frames nearest to a frame at a certain temporal level. A block matching algorithm (BMA) has been widely used in motion estimation. In the BMA, pixels in a current block are compared with pixels of a search area in a reference frame and a displacement with a minimum error is determined as a motion vector. While fixed-size block matching is used for motion estimation, hierarchical variable size block matching (HVSBM) may be used.

The temporal predictor 112 reconstructs a reference frame using the obtained motion vectors to generate a predicted frame and calculates a difference between the current frame and the predicted frame to generate a high-pass frame at the current frame position. The high-pass frame Hᵢ may be defined by Equation (1) when I₂ᵢ₊₁ is a (2i+1)-th low-pass frame or input frame and P(I₂ᵢ₊₁) is a predicted frame for the low-pass frame I₂ᵢ₊₁:
Hᵢ=I₂ᵢ₊₁−P(I₂ᵢ₊₁) (1)

P(I₂ᵢ₊₁) can be defined by Equation (2):

$$P ( {I}_{2 i + 1} ) = \frac{1}{2} ( MC ( {I}_{2 i} , {MV}_{2 i + 1 -> 2 i} ) + MC ( {I}_{2 i + 2} , {MV}_{2 i + 1 -> 2 i + 2} ) ) \qquad ( 2 )$$

where MV_{2i+1->2i} and MV_{2i+1->2i+2} respectively denote a motion vector directing from a 2i+1-th frame to a 2i-th frame and a motion vector directing from a 2i+1-th frame to a 2i+2-th frame and MC( ) denotes a motion-compensated frame obtained using the motion vector. The high-pass frames generated using the above-mentioned process are stored in the frame buffer 115 and provided to the spatial transformer 130.
The updater 116 updates a current frame among frames located at low-pass frame (2i-th) positions using the motion vectors generated by the motion estimator 113 and high-pass frames stored in the frame buffer 115 and generates a low-pass frame Lᵢ at the current frame position.

As shown in the following Equation (3), the update is performed using two high-pass frames preceding and following the current frame. Here, U(I₂ᵢ) is a frame added to the current frame for update.
Lᵢ=I₂ᵢ+U(I₂ᵢ) (3)

U(I₂ᵢ) can be defined by Equation (4):

$$U ( {I}_{2 i} ) = \frac{1}{4} ( MC ( {H}_{i - 1} , {MV}_{2 i -> 2 i - 1} ) + MC ( {H}_{i} , {MV}_{2 i -> 2 i + 1} ) ) \qquad ( 4 )$$

Here, motion vector MV_{2i->2i-1} has the same value of MV_{2i-1->2i} used in temporal prediction but has a different sign of MV_{2i-1->2i}. Because there is no one-to-one mapping between motion vectors in the current frame and the reference frame, an unconnected pixel (or region) can occur.

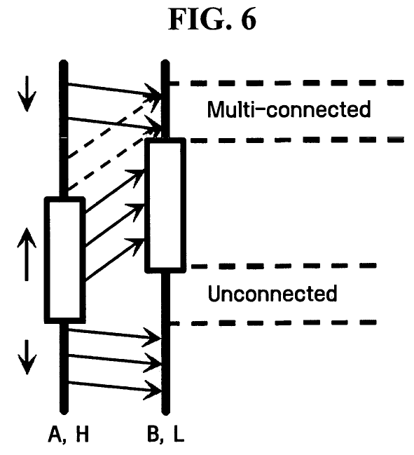

Referring to FIG. 6, assuming that a high-pass frame for an A frame is obtained using a B frame as a reference frame, all pixels in the A frame have motion vectors. This means that all pixels in the B frame do not have motion vectors. When a plurality of pixels in the A frame correspond to one pixel in the B frame, the pixel in the B frame is called a ‘multi-connected’ pixel. A pixel in the B frame corresponding to no pixel in the A frame is called an “unconnected” pixel. While one of a plurality of motion vectors can be selected for a multi-connected pixel, a new method for calculating U(I₂ᵢ) needs to be defined for an unconnected pixel having no corresponding motion vector.

In the case of an unconnected pixel, MC(Hᵢ₋₁,MV_{2i->2i-1}) and MC(Hᵢ,MV_{2i->2i+1}) can simply be replaced with I₂ᵢ to obtain U(I₂ᵢ). When a pixel in the frame I₂ᵢ is an unconnected pixel corresponding to no pixel in frame I₂ᵢ₋₁ but corresponds to a pixel in frame I₂ᵢ₊₁, Equation (4) may be modified into the following Equation (5):

$$U ( {I}_{2 i} ) = \frac{1}{4} ( {I}_{2 i} + MC ( {H}_{i} , {MV}_{2 i -> 2 i + 1} ) ) \qquad ( 5 )$$

The low-pass frame generated by the updater 116 is then stored in the frame buffer 114. The low-pass frame stored in the frame buffer is again fed into the separator 111 to perform temporal prediction and temporal update steps for the next temporal level. When all steps have been performed by the MCTF coding unit 110 for all temporal levels, a low-pass frame at the last temporal level processed by the MCTF coding unit 110 is fed into the closed-loop coding unit 120.

While it is described above that the MCTF is performed using a 5/3 filter, it will be readily apparent to those skilled in the art that a Haar filter or 7/5 or 9/7 filter with a longer tap can be used in place of 5/3 filter. Further, unlike in the present exemplary embodiment, temporal prediction or update may be performed using non-neighboring frames.

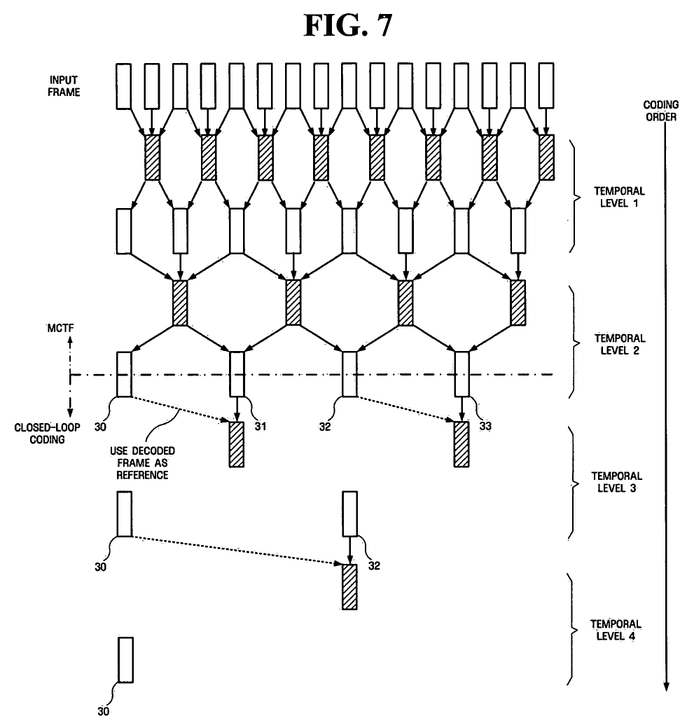

FIG. 7 illustrates an example of an encoding process including prediction and update steps for temporal levels 1 and 2 performed by the MCTF coding unit (110 of FIG. 3) and those for higher temporal levels performed by the closed-loop coding unit 120. When maximum time delay is 6, the MCTF coding unit 110 can perform MCTF up to temporal level 2. Then, the closed-loop coding unit 120 performs closed-loop coding on the last four low-pass frames 30 through 33 at temporal level 2 updated by the MCTF coding unit 110. To generate a high-pass frame, a predicted frame (inversely predicted frame) of a current frame is formed using the previous frame as a reference and the predicted frame is then subtracted from the current frame. The previous frame is not a low-pass frame input from the MCTF coding unit 110 but a decoded frame (indicated by a dotted line) obtained by quantizing and inversely quantizing the low-pass frame. It should be noted that the closed-loop coding uses a decoded version of a frame obtained by encoding an original frame used as a reference in encoding another frame.

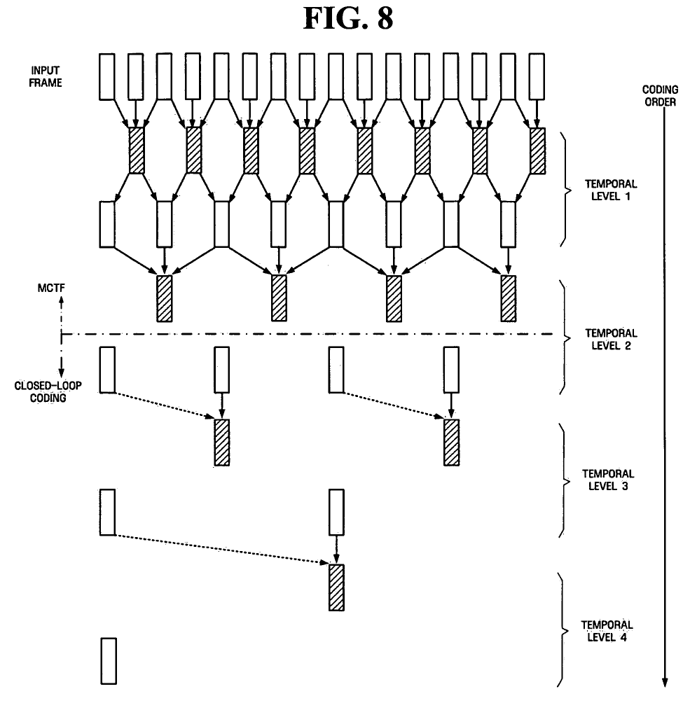

While FIG. 7 shows that the MCTF coding unit 110 performs MCTF up to temporal level 2, MCTF may be performed up to a temporal prediction step at a specific temporal level. FIG. 8 illustrates another example of an encoding process in which the MCTF coding unit 110 performs MCTF up to a prediction step for a specific temporal level. When a maximum time delay is 4, an update step cannot be performed for temporal level 2. In this case, four updated low-pass frames at positions in a first temporal level corresponding to those at temporal level 2 are fed to the closed-loop coding unit 120 for hierarchical closed-loop coding.

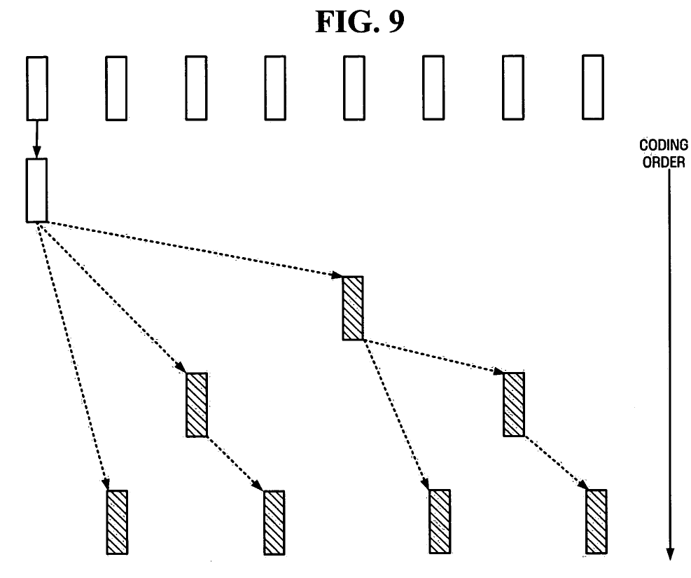

FIG. 9 illustrates an example of an encoding process in which closed-loop coding is applied to a Successive Temporal Approximation and Referencing (STAR) algorithm. More information about the STAR algorithm has been presented in a paper titled Successive Temporal Approximation and Referencing (STAR) for improving MCTF in Low End-to-end Delay Scalable Video Coding (ISO/IEC JTC 1/SC 29/WG 11, MPEG2003/M10308, Hawaii, USA, December 2003). Unlike a technique used the for closed-loop coding shown in FIG. 7 or 8, the STAR algorithm is a hierarchical encoding method in which an encoding process is performed in the same way as a decoding process. Thus, a decoder that receives some frames in a group of pictures (GOP) can reconstruct a video at a low frame rate. In this way, the closed-loop coding unit 120 may encode the low-pass frames received from the MCTF coding unit 110 using a STAR algorithm. The STAR algorithm differs from a conventional STAR algorithm (open-loop technique) in that a decoded image is used as a reference frame instead of an original image.

Turning to FIG. 5, the closed-loop coding unit 120 includes a motion estimator 121, a motion compensator 122, a frame buffer 123, a subtractor 124, an adder 125, an inverse quantizer 126, and an inverse spatial transformer 127.

The frame buffer 123 temporarily stores a low-pass frame L input from the MCTF coding unit 110 and a decoded frame D that will be used as a reference frame.

The initial frame 30 shown in FIG. 7 is fed into the frame buffer 123 and passes through the adder 123 to the spatial transformer 130. Because there is a predicted frame being added to the initial frame 30 by the adder 125, the initial frame 30 is fed directly into the spatial transformer 130 without being added to the predicted frame. The initial frame 30 is then subjected to spatial transform, quantization, inverse quantization, and inverse spatial transform and stored in the frame buffer 123 for use as a reference in encoding subsequent frames. Similarly, the subsequent frames are converted into high-pass frames that are then subjected to the same processes (spatial transform, quantization, inverse quantization, and inverse spatial transform), are added to predicted frames P, and stored in the frame butter 123 for use as a reference in encoding other frames.

The motion estimator 121 performs motion estimation on the current frame using a decoded frame stored for use as a reference to obtain motion vectors. A BMA has been widely used in this motion estimation.

The motion compensator 122 uses the motion vectors to reconstruct a reference frame and generates a predicted frame P.

The subtractor 124 calculates a difference between the current frame L and the predicted frame P to generate an inter-frame for the current frame L, which is then sent to the spatial transformer 130. Of course, when the current frame L is an intra-frame generated without reference to another frame like the initial frame 30 described above, the intra-frame bypasses the subtractor 124 and is fed directly to the spatial transformer 130.

The inverse quantizer 126 inversely quantizes the result obtained by the quantizer 140 in order to reconstruct a transform coefficient. The inverse spatial transformer 127 performs inverse spatial transform on the transform coefficient to reconstruct a temporal residual frame.

The adder 125 adds the temporal residual frame to the predicted frame P to obtain a decoded frame D.

A hierarchical closed-loop coding process will now be described with reference to FIG. 7. First, among the frames received from the MCTF coding unit 110, the initial frame 30 is intra-coded (encoded without reference to any other frame).

A next frame 31 is then inter-coded (encoded with reference to another frame) using a decoded version of the intra-coded frame as a reference. Similarly, a next frame 32 is inter-coded using the decoded version of the intra-coded frame as a reference.

The last frame 33 is inter-coded using a decoded version of the frame obtained after inter-coding the frame 32 as a reference.

While it is described above that it is determined for which temporal level MCTF coding or closed-loop coding will be performed according to a maximum time delay, a method combining the MCTF coding and the closed-loop coding may be used to improve the coding efficiency regardless of the maximum time delay.

The result of experiments showed that a hybrid method combining MCTF (including an update step) and hierarchical closed-loop coding offers better coding efficiency than when MCTF or hierarchical closed-loop coding is separately used. When MCTF or hierarchical closed-loop coding is individually applied, hierarchical closed-loop coding exhibits better coding efficiency than MCTF.

While MCTF has proved to be an efficient coding tool for temporal prediction at a low temporal level, i.e., filtering between adjacent frames, it suffers a significant decrease in coding efficiency for filtering at a high temporal level because a temporal interval between frames increases as the temporal level increases. Since frames with a larger temporal interval typically have lower temporal correlation, update performance is significantly degraded.

Conversely, the hierarchical closed-loop coding using a decoded frame as a reference frame does not suffer a significant decrease in coding efficiency due to an increase in temporal interval. Thus, the hybrid method combining advantages of the two methods offers the highest coding efficiency.

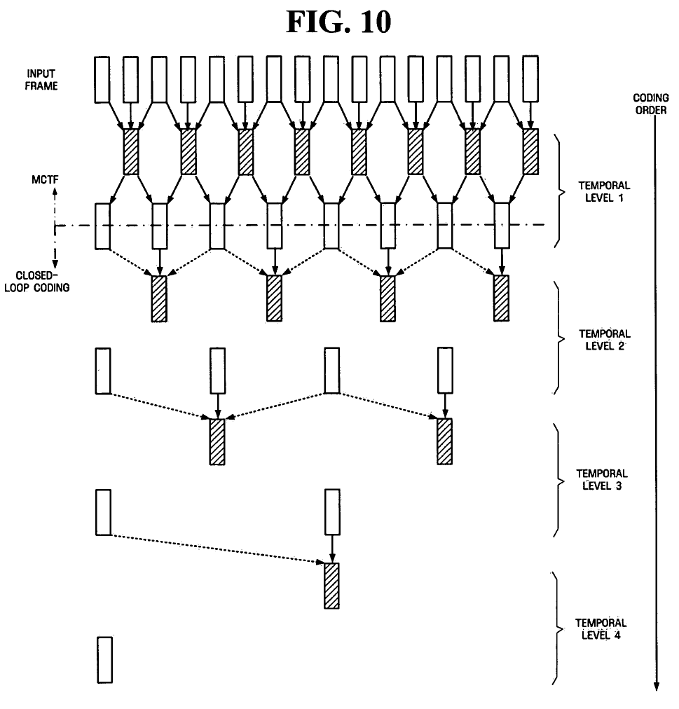

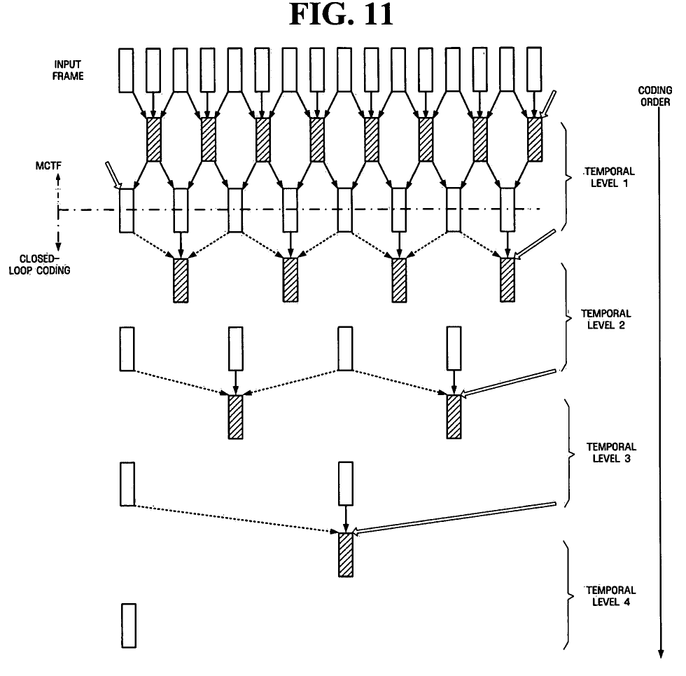

When both forward and backward prediction is used without considering time delay as shown in FIG. 10, a hybrid structure combining MCTF with hierarchical closed-loop coding still offers excellent coding efficiency. While it is described above that referencing is made within a GOP, it will become obvious to one skilled in the art that a frame in another GOP is used as a reference as indicated by double arrows in FIG. 11.

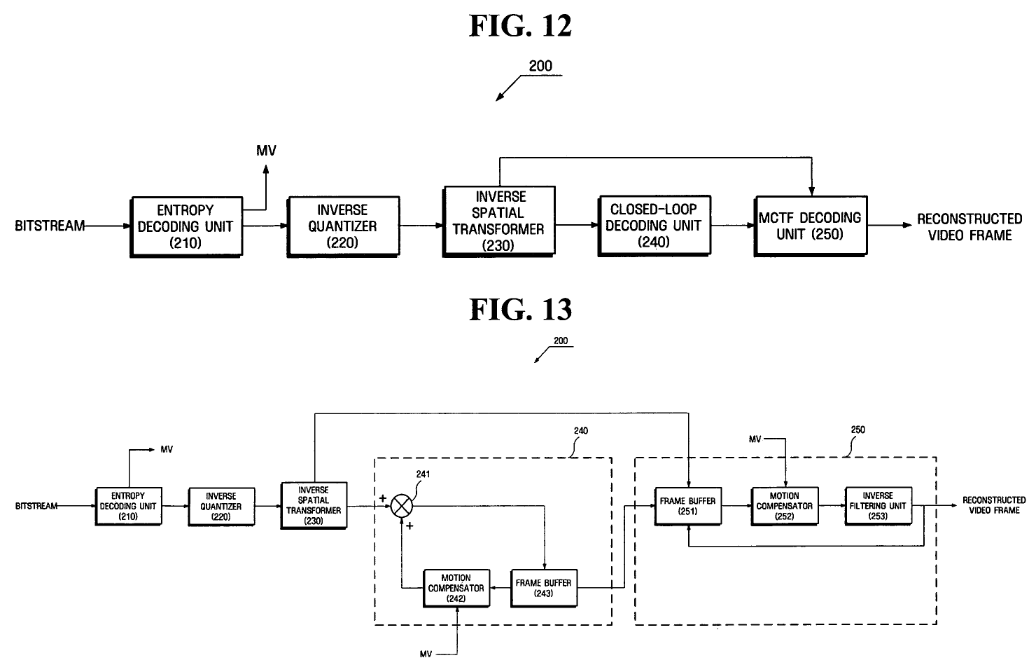

FIG. 12 is a block diagram of a video decoder 200 according to an exemplary embodiment of the present invention. Referring to FIG. 12, the video decoder 200 includes an entropy decoding unit 210, an inverse quantizer 220, an inverse spatial transformer 230, a closed-loop decoding unit 240, and a MCTF decoding unit 250.

The entropy decoding unit 210 interprets an input bitstream and performs the inverse of entropy coding to obtain texture data and motion data. The motion data may contain motion vectors and additional information such as block information (block size, block mode, etc). In addition, the entropy decoding unit 210 may obtain information about a temporal level contained in a bitstream. The temporal level information contains information about up to which temporal level MCTF coding, more specifically, a temporal prediction step is applied. When the temporal level is predetermined between the encoder 100 and decoder 200, the information may not be contained in the bitstream.

The inverse quantizer 220 performs inverse quantization on the texture data to output transform coefficients. The inverse quantization is the process of reconstructing quantization coefficients from matched quantization indices created at the encoder 100. A matching table between the indices and quantization coefficients may be received from the encoder 100 or predetermined between the encoder and the decoder.

The inverse spatial transformer 230 performs inverse spatial transform on the transform coefficients to generate frames in a spatial domain. When the frame in the spatial domain is an inter-frame, it will be a reconstructed temporal residual frame.

An inverse DCT or inverse wavelet transform may be used in inverse spatial transform according to the technique used at the encoder 100.

The inverse spatial transformer 230 sends an intra-frame and an inter-frame to the closed-loop decoding unit 240 while providing a high-pass frame to the MCTF decoding unit 250.

The closed-loop decoding unit 240 uses the intra-frame and the inter-frame received from the inverse spatial transformer 230 to reconstruct low-pass frames at the specific temporal level. The reconstructed low-pass frames are then sent to the MCTF decoding unit 250.

The MCTF decoding unit 250 performs inverse MCTF on the low-pass frames received from the closed-loop decoding unit 240 and the high-pass frames received from the inverse spatial transformer 230 to reconstruct entire video frames.

FIG. 13 is a block diagram showing the detailed construction of the video decoder of FIG. 12.

Referring to FIG. 13, the closed-loop decoding unit 240 includes an adder 241, a motion compensator 242, and a frame buffer 243. An intra-frame and an inter-frame at a temporal level higher than the specific temporal level are sequentially fed to the adder 241.

First, the intra-frame is fed to the adder 241 and temporarily stored in the frame buffer 243. In this case, since no frame is received from the motion compensator 242, no data is added to the intra-frame. The intra-frame is one of the low-pass frames.

Then, an inter-frame at the highest temporal level is fed to the adder 241 and added to a frame motion-compensated using the stored intra-frame to reconstruct a low-pass frame at the specific temporal level. The reconstructed low-pass frame is again stored in the frame buffer 243. The motion-compensated frame is generated by the motion compensator 242 using the motion data (motion vectors, block information, etc) received from the entropy decoding unit 210.

Subsequently, an inter-frame at the next temporal level is reconstructed using a frame stored in the frame buffer 243 as a reference frame. The above process is performed until all low-pass frames at the specific temporal level are reconstructed.

When all the low-pass frames at the specific temporal level are reconstructed, the low-pass frames stored in the frame buffer 243 are sent to the MCTF decoding unit 250.

The MCTF decoding unit 250 includes a frame buffer 251, a motion compensator 252, and an inverse filtering unit 253. The frame buffer 251 temporarily stores the high-pass frames received from the inverse spatial transformer 230, the low-pass frames received from the closed-loop decoding unit 240, and frames subjected to inverse filtering by the inverse filtering unit 253.

The motion compensator 252 provides a motion-compensated frame required for inverse filtering in the inverse filtering unit 253. The motion-compensated frame is obtained using the motion data received from the entropy decoding unit 210.

The inverse filtering unit 253 performs inverse temporal update and temporal prediction steps at a certain temporal level to reconstruct low-pass frames at a lower temporal level. Thus, when an MCTF 5/3 filter is used, reconstructed low-pass frames I₂ᵢ, and I₂ᵢ₊₁ are defined by Equation (6):

$$\begin{matrix}{I}_{2 i} = {L}_{i} - \frac{1}{4} ( MC ( {H}_{i - 1} , {MV}_{2 i -> 2 i - 1} ) + MC ( {H}_{i} , {MV}_{2 i -> 2 i + 1} ) ) \\ {I}_{2 i + 1} = {H}_{i} + \frac{1}{2} ( MC ( {I}_{2 i} , {MV}_{2 i + 1 -> 2 i} ) + MC ( {I}_{2 i + 2} , {MV}_{2 i + 1 -> 2 i + 2} ) )\end{matrix} \qquad ( 6 )$$

In the case of a connected pixel and a multi-connected pixel, Equation (6) is satisfied. Of course, the decoder 200 reconstructs the low-pass frames I₂ᵢ, and I₂ᵢ₊₁ considering that the encoder 100 simply replaces MC(Hᵢ₋₁,MV_{2i->2i-1}) and MC(Hᵢ,MV_{2i->2i+1}) with I₂ᵢ in the case of an unconnected pixel. When the unconnected pixel updated using Equation (5) is reconstructed, I₂ᵢ is newly defined by Equation (7):

$${I}_{2 i} = \frac{4}{5} {L}_{i} - \frac{1}{5} MC ( {H}_{i} , {MV}_{2 i -> 2 i + 1} ) \qquad ( 7 )$$

While it is described above that inverse filtering is performed using a 5/3 filter, it will be readily apparent to those skilled in the art that the decoder 200 may perform inverse filtering using a Haar filter or 7/5 or 9/7 filter with a longer tap in place of the 5/3 filter like in the MCTF at the encoder 100.

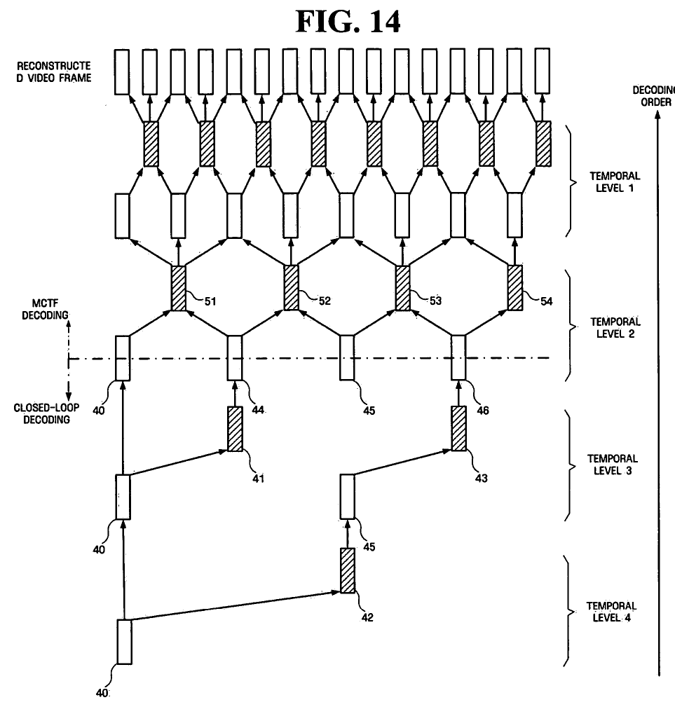

FIG. 14 illustrates a decoding process including hierarchical closed-loop decoding and MCTF decoding when an encoding process is performed as shown in FIG. 7.

One intra-frame 40 and 15 inter-frames or high-pass frames (indicated by gray) are generated by the inverse spatial transformer 230. The intra-frame 40 and three inter-frames 41, 42, and 43 at a temporal level higher than a specific temporal level, i.e., temporal level 2, are sent to the closed-loop decoding unit 240. The remaining 12 high-pass frames are sent to the MCTF decoding unit 250.

The closed-loop decoding unit 240 first reconstructs a low-pass frame 45 from the inter-frame 42 at temporal level 4 using the intra-frame 40 as a reference frame. Similarly, a low-pass frame 44 is reconstructed from the inter-frame 41 using the intra-frame 40 as a reference frame. Lastly, a low-pass frame 46 is reconstructed from the inter-frame 43 using the reconstructed low-pass frame 45 as a reference frame. As a result, all low-pass frames 40, 44, 45, and 46 at temporal level 2 are reconstructed.

Meanwhile, the MCTF decoding unit 250 uses the reconstructed low-pass frames 40, 44, 45, and 46 and frames 51, 52, 53, and 54 at temporal level 2 among the 12 high-pass frames received from the inverse spatial transformer 230 to reconstruct 8 low-pass frames at first temporal level. Finally, the MCTF decoding unit 250 uses the reconstructed 8 low-pass frames and the 8 inter-frames (high-pass frames at first temporal level) to reconstruct 16 video frames.

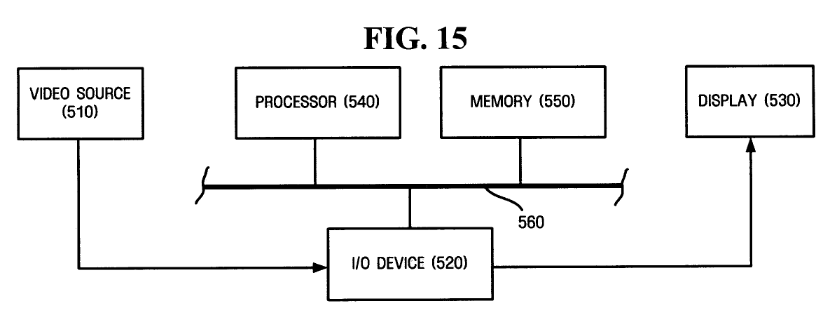

FIG. 15 is a block diagram of a system for performing an encoding or decoding process according to an exemplary embodiment of the present invention. The system may represent a television, a set-top box, a desktop, laptop or palmtop computer, a personal digital assistant (PDA), a video storage device such as a video cassette recorder (VCR), a digital video recorder (DVR), etc., as well as portions or combinations of these and other devices. The system includes at least one video source 510, at least one input/output device 540, a processor 520, a memory 550, and a display 530.

The video source 510 may represent, e.g., a television receiver, a VCR or other video/image storage device. The source 510 may alternatively represent one or more network connections for receiving video from a server or servers over, e.g., a global computer communications network such as the Internet, a wide area network, a metropolitan area network, a local area network, a terrestrial broadcast system, a cable network, a satellite network, a wireless network, or a telephone network, as well as portions or combinations of these and other types of networks.

The input/output devices 520, the processor 540 and the memory 550 may communicate over a communication medium 560. The communication medium 560 may represent, e.g., a bus, a communication network, one or more internal connections of a circuit, circuit card or other device, as well as portions and combinations of these and other communication media. Input video data from the source 510 is processed in accordance with one or more software programs stored in the memory 550 and executed by the processor 540 in order to generate output video/images supplied to the display device 530.

In particular, the codec may be stored in the memory 550, read from a storage medium such as CD-ROM or floppy disk, or downloaded from a server via various networks. The codec may be replaced with a hardware circuit or a combination of software and hardware circuits according to the software program.

While the present invention has been particularly shown and described with reference to exemplary embodiments thereof, it will be understood by those of ordinary skill in the art that various changes in form and details may be made therein without departing from the spirit and scope of the present invention as defined by the following claims. Therefore, it is to be understood that the above-described exemplary embodiments have been provided only in a descriptive sense and will not be construed as placing any limitation on the scope of the invention.

According to exemplary embodiments of the present invention, an MCTF structure is combined with hierarchical closed-loop coding, and it is possible to solve a time delay problem that may occur when temporal scalability is implemented. In addition, the present invention exploits advantages of both MCTF structure and hierarchical closed-loop coding, thereby improving the video compression efficiency.

Although the present invention has been described in connection with the exemplary embodiments of the present invention, it will be apparent to those skilled in the art that various modifications and changes may be made thereto without departing from the scope and spirit of the invention. Therefore, it should be understood that the above embodiments are not limitative, but illustrative in all aspects.

What is claimed is:

1. A video encoding method supporting temporal scalability, the method comprising:
performing Motion-Compensated Temporal Filtering (MCTF) on input frames up to a first temporal level;
performing hierarchical closed-loop coding on frames generated by the MCTF, up to a second temporal level higher than the first temporal level;
performing spatial transform on frames generated using the hierarchical closed-loop coding to create transform coefficients; and
quantizing the transform coefficients.

2. The video encoding method of claim 1, wherein the performing of the hierarchical closed-loop coding comprises performing the hierarchical closed-loop coding on last low-pass frames generated using the MCTF up to the highest temporal level.

3. The video encoding method of claim 1, wherein the performing of the spatial transform comprises creating transform coefficients using a high-pass frame among the frames generated by the MCTF and an intra-frame and an inter-frame generated by performing the hierarchical closed-loop coding.

4. The video encoding method of claim 1, wherein the temporal level is determined according to a maximum limit of time delay.

5. The video encoding method of claim 3, wherein the performing of the MCTF comprises:
separating the input frames into frames at high-pass frame positions and at low-pass frame positions;
performing motion estimation on a frame at the high-pass frame position using adjacent frames to obtain motion vectors;
reconstructing a reference frame using the motion vectors to generate a predicted frame and calculating a difference between a current frame and the predicted frame to generate a high-pass frame;
updating a frame at a low-pass frame position using the motion vectors and the frame at the high-pass frame position; and
replacing one of the input frames with the updated frame and repeating the separating of the input frames, the performing of the motion estimation, the generating of the high-pass frame, and the updating of the frame at the low-pass frame position up to a temporal level.

6. The video encoding method of claim 1, wherein the MCTF is performed using a 5/3 filter.

7. The video encoding method of claim 1, wherein the MCTF is performed using a Haar filter.

8. The video encoding method of claim 2, wherein the performing of the hierarchical closed-loop coding comprises:
encoding a first frame being used among the last low-pass second frames as a reference to another frame and decoding the encoded first frame;
obtaining motion vectors for a second frame in the last low-pass frames using the decoded first frame as a reference;
using the motion vectors to generate a predicted frame for the second frame;
calculating a difference between the second frame and the predicted frame to generate an inter-frame; and
replacing the last low-pass frame with the first frame and repeating the encoding of the first frame, the obtaining of the motion vectors, the generating of the predicted frame, and the generating of the inter-frame up to the highest temporal level.

9. A video decoding method supporting temporal scalability, the method comprising:
extracting texture data and motion data from an input bitstream;
performing inverse quantization on the texture data to output transform coefficients;
using the transform coefficients to generate frames in a spatial domain;
using an intra-frame and an inter-frame among the frames in the spatial domain to reconstruct low-pass frames at a specific temporal level; and
performing inverse Motion-Compensated Temporal Filtering (MCTF) on high-pass frames among the frames in the spatial domain and the reconstructed low-pass frames to reconstruct video frames.

10. The video decoding method of claim 9, wherein the specific temporal level is contained in the bitstream and received from a video encoder.

11. A video encoder supporting temporal scalability, comprising:
a Motion-Compensated Temporal Filtering (MCTF) coding unit which performs MCTF on input first frames up to a first temporal level;
a closed-loop coding unit which performs hierarchical closed-loop coding on second frames up to a second temporal level higher than the first temporal level, the second frames being generated by the MCTF coding unit;
a spatial transformer which performs spatial transform on third frames generated by the hierarchical closed-loop coding unit to create transform coefficients; and
a quantizer performing quantization on the transform coefficients.

12. The video encoder of claim 11, wherein the closed-loop coding unit performs the hierarchical closed-loop coding on last low-pass second frames generated by the MCTF coding unit up to the highest temporal level.

13. The video encoder of claim 12, wherein the spatial transformer performs the spatial transform on a high-pass frame among the second frames generated by the MCTF coding unit and an intra-frame and an inter-frame of the third frames generated by the closed-loop coding unit to create transform coefficients.

14. The video encoder of claim 11, wherein a specific temporal level is determined according to a maximum limit of time delay.

15. The video encoder of claim 13, wherein the MCTF coding unit comprises:
a separator which separates the input first frames into frames at high-pass frame positions and at low-pass frame positions;
a motion estimator which performs motion estimation on a frame at the high-pass frame position using adjacent frames to obtain motion vectors;
a temporal predictor which reconstructs a reference frame using the motion vectors to generate a predicted frame and calculating a difference between a current frame and the predicted frame to generate the high-pass frame; and
an updater which updates a frame at a low-pass frame position using the motion vectors and the high-pass frame.

16. The video encoder of claim 11, wherein the MCTF coding unit comprises a 5/3 filter.

17. The video encoder of claim 11, wherein the MCTF coding unit comprises a Haar filter.

18. The video encoder of claim 13, wherein the closed-loop coding unit comprises:
an encoding which encodes a fourth frame being used among the last low-pass frames as a reference to another frame and decoding the encoded fourth frame;
a motion estimator which obtains motion vectors for a second frame in the last low-pass frames using the decoded fourth frame as a reference;
a motion compensator which uses the motion vectors to generate a predicted frame for the second frame; and
an adder which calculates a difference between the second frame and the predicted frame to generate an inter-frame.

19. A video decoder supporting temporal scalability, the video decoder comprising:
an entropy decoding unit which extracts texture data and motion data from an input bitstream;
an inverse quantizer which performs inverse quantization on the texture data to output transform coefficients;
an inverse spatial transformer which uses the transform coefficients to generate frames in a spatial domain;
a closed-loop decoding unit which uses an intra-frame and an inter-frame among the frames in the spatial domain to reconstruct low-pass frames at a specific temporal level; and
a Motion-Compensated Temporal Filtering (MCTF) decoding unit which performs inverse MCTF on high-pass frames among the frames in the spatial domain and the reconstructed low-pass frames to reconstruct video frames.

20. The video decoder of claim 19, wherein the specific temporal level is contained in the bitstream and received from a video encoder.
